(19) United States
(12) Patent Application Publication
(10) Pub. No.: US 2022/0170469 A1
(43) Pub. Date: Jun. 2, 2022

(54) Counter-Rotating Fan Assembly

(71) Applicant: Robert Bosch GmbH, Stuttgart (DE)

(72) Inventor: Robert Van Houten, Winchester, MA (US)

(21) Appl. No.: 17/535,216

(22) Filed: Nov. 24, 2021

Related U.S. Application Data
(60) Provisional application No. 63/120,392, filed on Dec. 2, 2020.

(51) Int. Cl. F04D 19/02; F04D 25/06; F04D 29/38; F04D 29/54; F04D 29/58; F04D 29/64

(52) U.S. Cl. CPC F04D 19/024; F04D 25/0606; F04D 29/644; F04D 29/541; F04D 29/5826; F04D 29/384

(57) ABSTRACT

A counter-rotating fan assembly includes an upstream fan that rotates in a first direction about a common axis and a downstream fan that rotates in a second, opposed direction about the common axis. The assembly has an upstream motor that drives the upstream fan, and an upstream motor support that supports the upstream motor. The assembly also has a downstream motor that drives the downstream fan, and a downstream motor support that supports the downstream motor. The upstream motor support is located upstream of the upstream fan, and the downstream motor support is located downstream of the downstream fan.

### BACKGROUND

Although current automobiles employ a variety of powertrains, there is in every case a requirement to provide cooling. Typically this cooling function is achieved by the use of axial fans mounted in such a way that one Of more fans either push or pull an through a stack of one or more heat exchangers. These heat exchangers can include radiators, condensers, charge-air coolers, and other types of heat exchanger. If multiple fans are employed they are typically oriented “side-by-side”, moving air in parallel. This is typically the case when the shape of the heat exchangers does not lend itself to the use of a single fan.

Automotive cooling fans are typically located at the front of the vehicle, often behind a grill. When the vehicle is moving, the air pressure in front of the vehicle increases. A portion of this pressure increase is applied to the front surface of the heat exchangers. This allows the fan or fans to move more air, and provide more cooling.

The fans are typically powered by electric motors, which are supported by structures connected to shrouds which surround the one or more fans, and guide the air between the heat exchangers and the fans. These motor supports may advantageously include a set of vanes that extend from a motor mount to the shroud in an approximately radial direction. As used herein, the term radial is used with reference to a rotation axis of the fans, and refers to a direction that is perpendicular to the rotation axis.

These motors require electric power provided by one or more alternators, or by a battery. To maximize the range of an electric vehicle, or to minimize the fuel consumption of an engine-powered vehicle, the fans are designed to be as efficient as possible. One cause of inefficiency is the swirl induced into the air stream leaving the fan, which represents energy lost to the system.

Efforts to capture the energy lost due to swirl of the airstream leaving the fans, and thereby increase the efficiency of the fans, have been directed towards the use of counter-rotating fans. In this configuration, two fans are mounted on the same rotation axis, and turn in opposite directions. The downstream fan can thereby recover the swirl energy imparted by the upstream fan, so that the velocity of the air leaving the downstream fan is primarily axial. As used herein, the terms “upstream” and “downstream” refer to a relative position with respect to the direction of airflow through the fan assembly. The tern “axial” refers to the direction of the rotation axis.

In order to power a counter-rotating fan assembly, one can use either a single, counter-rotating motor, or two motors, each driving one of the fans.

SUMMARY

A counter-rotating fan assembly is described herein in which each fan is driven by a separate motor, each motor is supported by a separate motor support, and each motor support is positioned in such a way that parasitic losses may be minimized. The positioning of the motor supports may also facilitate the cooling of the motors. The overall length of the fan assembly, as measured from the downstream face of the downstream-most heat exchanger, may also be minimized.

In one aspect, the counter-rotating fan assembly includes an upstream fan and a downstream fan, rotating in opposite directions around a substantially common axis. An upstream motor drives the upstream fan, and an upstream motor support supports the upstream motor. A downstream motor drives the downstream fan, and a downstream motor support supports the downstream motor. In addition, a barrel surrounds at least a portion of the upstream fan and a portion of the downstream fan. The upstream motor support is located upstream of the upstream fan and the downstream motor support is located downstream of the downstream fan.

In some embodiments of the fan assembly, the upstream and downstream motor supports include vanes. The vanes have cross sections that have a chord line, a chord length and a maximum thickness. The chord length is greater than the maximum thickness, and the chord line is oriented substantially in the direction of the rotation axis.

in some embodiments of the fan assembly, the chord length is between 4 and 15 times the maximum thickness.

In some embodiments of the fan assembly, the vanes have a leading edge, and the leading edge is rounded.

In some embodiments of the fan assembly, the vanes have a trailing edge, and the thickness at the trailing edge is less than the maximum thickness.

In some embodiments of the fan assembly, the counter-rotating fan assembly further includes an air guide configured to guide air between a heat exchanger and the fan assembly.

In some embodiments of the fan assembly, the counter-rotating fan assembly includes a provision whereby it can be attached to a separate air guide configured to guide air between a heat exchanger and the fan assembly.

In some embodiments of the fan assembly, the barrel and the upstream and downstream motor supports are injection molded of one or more plastic materials.

In some embodiments of the fan assembly, the air guide, the barrel, and the upstream and downstream motor supports are injection molded of one or more plastic materials.

In some embodiments of the fan assembly, the downstream motor support is integrally formed with a portion of the barrel, and the portion of the barrel surrounds at least a portion of the downstream fan and at least a portion of the upstream fan.

In some embodiments of the fan assembly, the radial dimension of the inner surface of the upstream end of the barrel portion is greater than the radial dimension of the inner surface of the downstream end of the barrel portion.

In some embodiments of the fan assembly, the upstream motor support is molded integrally with a ring structure that connects the outer extremities of the vanes.

In some embodiments of the fan assembly, the upstream motor support is integrally formed with the air guide.

In some embodiments of the fan assembly, the barrel is integrally formed with the air guide.

In some embodiments of the fan assembly, the upstream and downstream fans are free-tipped.

In some embodiments of the fan assembly, at least one of the upstream and downstream fans includes a band that connects the tips of the blades.

A method is described for assembling a counter-rotating fan assembly. The counter-rotating fan assembly includes an upstream fan and a downstream fan, rotating in opposite directions around a substantially common axis. The fan assembly includes an upstream motor driving the upstream fan, and an upstream motor support which supports the upstream motor, a downstream motor driving the downstream fan, and a downstream motor support which supports the downstream motor. In addition, the fan assembly includes a barrel surrounding at least a portion of the upstream fan and a portion of the downstream fan. The upstream motor support is located upstream of the upstream fan and the downstream motor support is located downstream of the downstream fan. The method includes assembling a first subassembly that includes the upstream fan, the upstream motor, and the upstream motor support, assembling a second subassembly that includes the downstream fan, the downstream motor, and the downstream motor support, and assembling the first subassembly with the second subassembly to provide a third subassembly.

### BRIEF DESCRIPTION OF THE FIGURES

FIG. 1a is a meridional view of a counter-rotating fan assembly.

FIG. 1b is a meridional view of a portion of a counter-rotating fan assembly according to an embodiment in which the barrel inlet is stepped.

FIG. 1c is a meridional view of a portion of a counter-rotating fan assembly according to an embodiment in which the barrel extends downstream to support the vanes of the downstream motor support.

FIG. 2a is the cylindrical section A-A, as indicated in FIG. 1a, showing the fan blades and support vanes.

FIG. 2b is a head-capacity curve of an automotive cooling fan, identifying an idle operating point and a ram-air operating point.

FIG. 2c is a vector diagram of the air velocity between the fans at the idle operating point identified on the head-capacity curve of FIG. 2b.

FIG. 2d is a vector diagram of the air velocity between the fans at the ram-air operating point identified on the head-capacity curve of FIG. 2b.

FIG. 2e is a plot of efficiency versus flow, in which the solid line represents the efficiency curve for a fan assembly having vanes disposed between the fans and the broken line represents the efficiency curve for a fan assembly having no vanes disposed between the fans, showing the benefit of a design without vanes between the upstream and downstream fans.

FIG. 3a is an exploded meridional view of the air guide, the barrel, and the upstream and downstream motor supports as molded in three separate, injection-molded parts.

FIG. 3b is an exploded meridional view of the air guide, the barrel, and the upstream and downstream motor supports as molded in two separate, injection-molded parts, with the upstream motor support integrally molded with the air guide.

FIG. 3c is an exploded meridional view of the air guide, the barrel, and the upstream and downstream motor supports as molded in two separate, injection-molded parts, with the barrel integrally molded with the air guide.

FIG. 4a is an enlarged view of the resulting structure when the three molded parts shown in FIG. 3a are fastened together.

FIG. 4b is an enlarged view of the resulting structure when the two molded parts shown in FIG. 3b are fastened together.

FIG. 4c is an enlarged view of the resulting structure when the two molded parts shown in FIG. 3c are fastened together.

FIG. 5 is a meridional view of a counter-rotating fan assembly according to an embodiment where the barrel inlet has almost the same transverse dimension as the heat exchanger, and the upstream motor support is connected to the side wall of the air guide.

FIG. 6 is a meridional view of a counter-rotating fan assembly according to an embodiment in which the upstream fan is banded.

FIG. 7 is a meridional view of a counter-rotating fan assembly according to an embodiment in which the fan assembly is located upstream of a set of heat exchangers.

### DETAILED DESCRIPTION

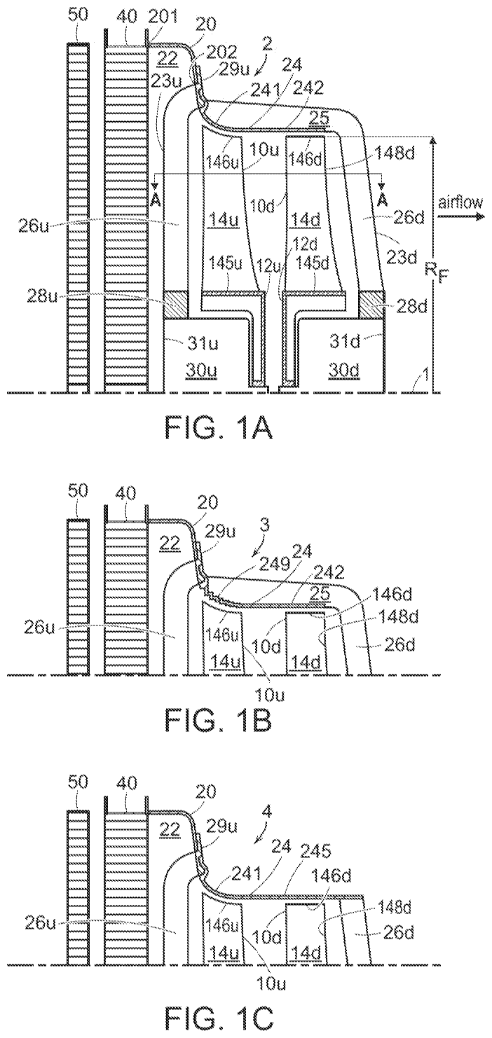

FIG. 1a shows a meridional section through an automotive radiator 50, a condenser 40. and a counter-rotating fan assembly 2. The condenser 50 is mounted in front of the radiator 40, to which an air guide 20 is attached. The fan assembly 2 is attached to the air guide 20. The fan assembly 2 pulls air through the condenser 50 and the radiator 40, and discharges the air in the direction indicated. The fan assembly 2 includes an upstream fan 10u and a downstream fan 10d. The upstream and downstream fans 10u, 10d are configured to rotate about a substantially common rotation axis 1, and turn in opposite directions, as discussed in detail below.

It is understood that, in use, the rotation axes of the upstream and downstream fans 10u, 10d may not be precisely common (e.g., co-linear). In some embodiments the axes are described as “substantially common” when they are parallel, but with a small distance between them. In other embodiments the axes are described as “substantially common” when there is a small angle formed between the axes, and the distance between the intersections of the two axes with a plane perpendicular to the rotation axis of the downstream fan that passes through the upstream-most portion of the hub of the downstream fan is sufficiently small. The small angle between the fan rotation axes may be less than twelve degrees, or less than six degrees, or less than three degrees. The small distance between the fan rotation axes may be less than twelve percent of the downstream fan diameter, or less than six, percent of the downstream fan diameter, or less than three percent of the downstream fan diameter. The downstream fan diameter is defined to be twice the radial distance RF from the downstream fan rotation axis to the downstream blade tip 146d at the trailing edge 148d.

The air guide 20 is a structure having an open upstream end that is attached to, or fixed adjacent to, the downstream-most heat exchanger, and an open downstream end that is attached to the fan assembly 2. In most embodiments, the upstream end 201 of the air guide 20 has a shape and dimensions that correspond to the shape and dimensions of the downstream-most heat exchanger, which is often rectangular. The downstream end 202 of the air guide 20 generally has a smaller area than the upstream end, whereby the air guide 20 serves to accelerate air into the fan assembly 2. In most embodiments, the downstream end 202 of the air guide 20 has a circular shape. The air guide 20 both guides the air and contains a volume of air which is at a lower pressure than the air surrounding the air guide 20.

The fan assembly 2 includes a barrel 24, which is a tubular structure that includes a flared inlet portion 241 and a cylindrical portion 242 that is disposed downstream of the inlet portion 241. The radial dimension of the inner surface of the upstream end of the inlet portion 241 is larger than the radial dimension of the inner surface of the cylindrical portion 242. The inlet portion 241 facilitates the smooth entrance of air into the barrel 24. In other embodiments, the inlet portion 241 may extend over a smaller or larger portion of the barrel 24, or even the entire barrel 24. The cylindrical portion 242 may be only approximately cylindrical. When molded as a plastic part, a required draft angle may dictate that the radial dimension varies slightly along the axial extent. In the illustrated embodiment, a dimension of the barrel in a direction parallel to the fan rotation axis 1 is less than the radial distance R_{F}. In other embodiments, the dimension of the barrel in a direction parallel to the fan rotation axis 1 is less than twice the radial distance R_{F}.

The upstream fan 10u is driven to rotate about the rotation axis 1 by an upstream electric motor 30u, which is mounted on an upstream motor mount 28u. The upstream motor mount 28u is supported by multiple vanes 26u which extend radially outward from the upstream motor mount 28u and are joined to the inner surface of a ring structure 29u. This ring structure 29u is attached to the air guide 20 in such a way that the inner wall of the ring structure 29u and the inner wall of the air guide 20 form a smooth surface. The upstream motor mount 28u and vanes 26u together provide an upstream motor support 23u that is positioned upstream of the upstream fan 10u.

The upstream fan 10u is a free-tipped fan, and includes a hub 12u, and multiple blades 14u. The tips 146u of the fan blades 14u are shaped to maintain an approximately constant clearance with respect to the barrel inlet portion 241. The barrel inlet portion 241 is configured to be attached to the ring structure 29u in such a way that the inner surface of the barrel inlet portion 241 and the inner surface of the ring structure 29u form a smooth surface.

The downstream fan 10d is driven to rotate about the rotation axis 1 in a direction opposite to that of the upstream fan 10u. The downstream fan 10d is driven by an electric motor 30d, which is mounted on a downstream motor mount 28d. The downstream motor mount 28d is supported by multiple vanes 26d which extend radially outward from the downstream motor mount 28d. The outer end of each vane 26d is joined to one of a plurality of axially-extending ribs 25 that protrude outward from an outer surface of the barrel 24. The downstream motor mount 28d and vanes 26d together provide a downstream motor support 23d that is positioned downstream of the downstream fan 10d.

The downstream fan 10d is a free-tipped fan, and includes a hub 12d, and multiple blades 14d. The tips 146 of the fan blades 14d maintain an approximately constant clearance with respect to the cylindrical portion of the barrel 242. The cylindrical portion 242 terminates at an axial position approximately adjacent to a trailing edge 148d of the blade 14d.

FIG. 1a shows an embodiment where the upstream fan blade tips 146u are located adjacent to the barrel inlet portion 241, and the downstream blade tips 146d are located adjacent to the cylindrical portion 242 of the barrel 24. In other embodiments, a portion of the upstream blade tips 146u may extend into the cylindrical portion 242 of the barrel 24. In still other embodiments, a portion of the downstream blade tips 146d may extend into the barrel inlet portion 241.

Because the motors 30u and 30d are facing in opposite directions, they can be identical, and still rotate the fans 10u and 10d in opposite directions. This can be advantageous when manufacturing the assembly.

The fan assembly 2 as shown in FIG. 1a features an arrangement of motor supports which is advantageous in that it can provide adequate cooling to the motors. Electric motors are less than 100 percent efficient, and the heat generated by the motors must be removed to avoid an overheated condition. The back side 31u of the upstream motor 30u is exposed to the air leaving the radiator 40. Although heated by the. radiator 40, this air is cooler than the upstream motor 30u, and can provide cooling. Similarly, the back side 31d of the downstream motor 30d is exposed to the air leaving the downstream fan 14d, and the ambient air downstream of the fan assembly. This air is cooler than the downstream motor 30d, and can provide cooling. The illustrated arrangement can be compared to some alternative arrangements of motor supports in counter-rotating fan assemblies in which one or more motors are positioned between the upstream fan and the downstream fan. In some cases, this alternative arrangement may be problematic in that there may be very little air moving over the motors to remove the generated heat.

Various additional embodiments of the fan assembly are described below. These embodiments feature fan assemblies which include features in common with the fan assembly 2 illustrated in FIG. 1a. These common elements are referred to with common reference numbers.

FIG. 1b shows another embodiment of the fan assembly. In the fan assembly 3 illustrated in FIG. 1b the inlet portion 249 of the barrel 24 is stepped, as described in U.S. patent application Ser. No. 15/563,842. The contents of U.S. patent application Ser. No. 15/563,842 are incorporated by reference herein. The stepped barrel geometry has been shown to reduce the noise of a free-tipped fan.

FIG. 1c shows another embodiment of the fan assembly. In the fan assembly 4 illustrated in FIG. 1c, portions of the cylindrical barrel portion 245 extend downstream beyond the trailing edge 148d of the downstream blade 14d, and are connected to the vanes 26d. The section shown in FIG. 1c is in a meridional plane at the azimuthal location of a vane. In other meridional planes at azimuthal locations between the vanes, the barrel 24 may be terminated near the trailing edge 148d of the downstream blade 14d. In other, similar, embodiments, the barrel 24 is stiffened with external ribs located at the azimuthal locations of the vanes.

The fan assemblies 2, 3, 4 shown in FIGS. 1a, 1b, and 1c are space-efficient. Because fans are typically somewhat smaller than the heat exchangers through which they draw air, the efficiency of the fan module is increased by increasing the axial distance between the heat exchanger and the inlet portion 241, 249 of the barrel 24. The space 22 enclosed by the air guide 20 allows the air which passes through the heat exchanger radially outward of the barrel inlet portion 241, 249 to enter the barrel inlet portion 241, 249 with a minimum of restriction. By placing the upstream motor support 23u upstream of the upstream fan 10u, the space between the barrel inlet portion 241, 249 and the heat exchanger serves both an aerodynamic and a structural function.

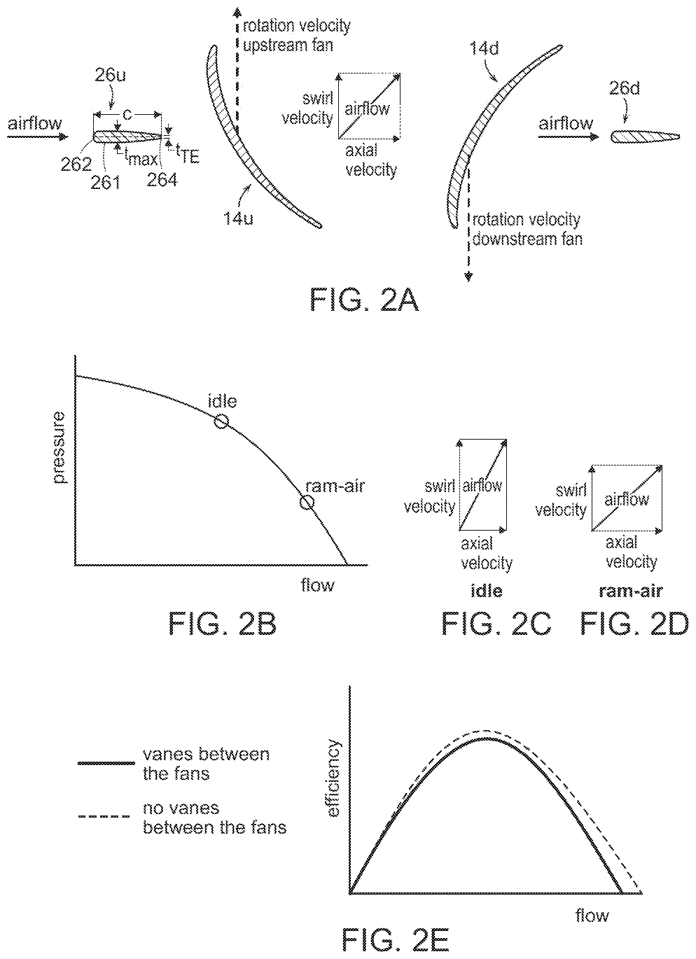

FIG. 2a is the cylindrical section A-A indicated in FIG. 1a. The cylindrical section represents the intersection of the vanes 26u, the fan blades 14u and 14d, and the vanes 26d with a cylinder the axis of which is the fan rotation axis 1. The cross section of each upstream vane 26u has a chord line 261 corresponding to a straight line that extends between the vane leading edge 262 and the vane trailing edge 264. The chord line. 261 has a chord length c which is the length of the chord line. In the illustrated embodiment, the chord length is approximately 6 times larger than the maximum thickness tₘₐₓ. The vane leading edge 262 is rounded, and the thickness t_{TE} at the vane trailing edge 264 is less than the maximum thickness tₘₐₓ. The size and shape of a given vane 26u may reduce the severity of the viscous wake downstream of the vane, and thereby decrease the drag of the vane and reduce the noise generated when a fan blade moves through the wake. The chord line 261 is generally aligned with the local airflow, and, as shown, is approximately parallel to the rotation axis 1. As used herein, the term “approximately parallel” is used to indicate that the angle between the chord line 261 and the rotation axis 1 is less than twelve degrees. In other embodiments, the term “approximately parallel” is used to indicate that the angle between the chord line 261 and the rotation axis 1 is less than six degrees. In still other embodiments, the term “approximately parallel” is used to indicate that the angle between the chord line 261 and the rotation axis 1 is less than three degrees. The cross section of the downstream vane 26d is similar in size, shape, and orientation. The downstream vane 26d is also generally aligned with the local airflow, and, as shown, is approximately parallel to the rotation axis 1. This relationship between the vane orientation and the air flow direction is maintained at all operating points.

FIG. 2a also shows schematically the rotation directions of an upstream blade 14u and a downstream blade 14d, as well as the direction of the airflow between the upstream blades 14u and the downstream blades 14d. At that location, the air has an axial velocity approximately equal to the axial velocity upstream, of the upstream blades 14u and downstream of the downstream blades 14d, but in addition has a swirl component of velocity. The total speed of the air is thereby increased.

FIG. 2b shows the head-capacity curve of a counter-rotating fan assembly such as the fan assembly 2 illustrated in FIG. 1a. In FIG. 2b, the vertical axis represents the pressure developed, and the horizontal axis represents the flow delivered. The operating point of the fan assembly 2 when the vehicle is stationary is shown as the “idle” point. The operating point when the vehicle is moving is shown as the “ram-air” point. At the ram-air point, the fan assembly 2 is generating less pressure, and is moving more air than at the idle point. FIGS. 2c and 2d are velocity, diagrams of the flow at a particular radius between the upstream and downstream blades 14u, 14d at the respective operating points. At the idle point (FIG. 2c), the swirl velocity is high, and the axial velocity is low, so the flow angle relative to the rotation axis 1 is quite large. At the ram-air point (FIG. 2d), the swirl velocity is low, the axial velocity is large, and the angle is smaller.

The designer of a fan assembly which places a support vane between the upstream and downstream fans must choose one operating point where the vane will be aligned with the local airflow. At other operating points the vane may be misaligned. When the vane is misaligned, the wake behind the vane may be more severe than in the case of an aligned vane, and the downstream fan may see a greater non-uniformity in velocity, and higher turbulence levels. The fan assembly may experience a loss of efficiency and increased noise.

The counter-rotating fan assembly 2 shown in FIGS. 1a and 2a benefits from the placement of the support vanes 26u, 26d in regions where the airflow direction is approximately axial at all operating points. One benefit is that the air velocity is relatively low in these regions, and the drag of a vane, which varies roughly as the square of the air velocity, will also be low. This can result in an increased efficiency. The other benefit is that no vane misalignment occurs when the operating point differs from the design point. This can result in higher efficiency and lower noise at off-design conditions. FIG. 2e depicts the change in the curve of efficiency that one might expect by moving vanes from a location between the fans to locations where the flow is axial at all operating conditions—both the height and the breadth of the curve may be increased.

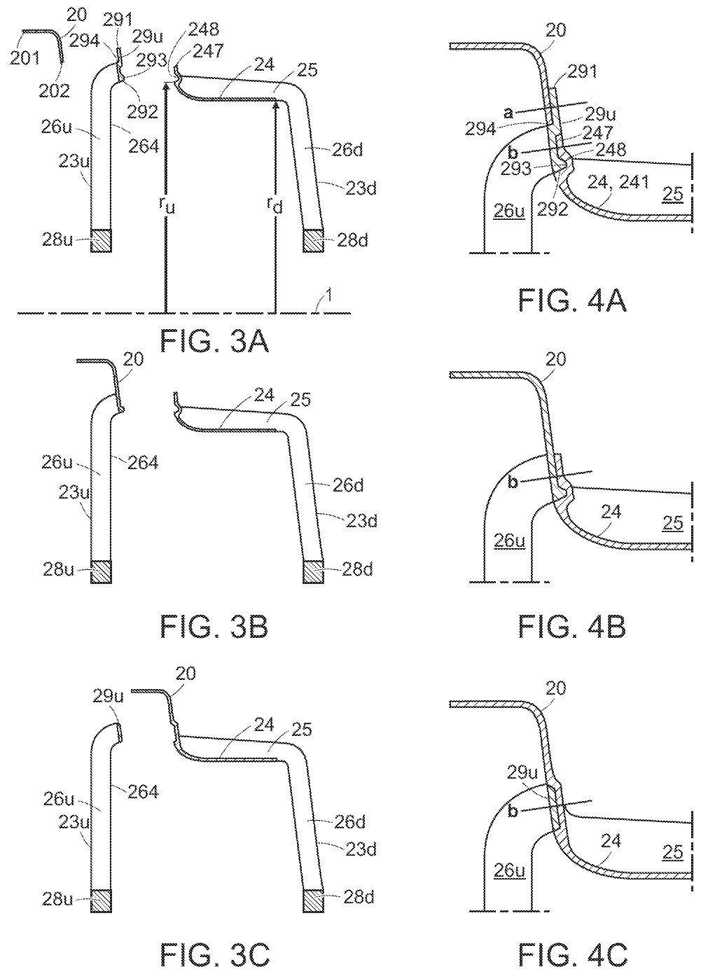

In some embodiments, the air guide 20, the barrel 24, and the upstream and downstream motor supports 23u, 23d are injection molded of a plastic material. For example, the air guide 20, the barrel 24, and the upstream and downstream motor supports 23u, 23d may be injection molded as three separate parts (FIG. 3a), which can be assembled with fasteners (FIG. 4a). An advantage of molding the air guide 20 as a separate part is that in some cases the air guide 20 can be made of a different material and to looser tolerances than the barrel 24 and the upstream and downstream motor supports 23u, 23d.

In other examples, the air guide 20, the barrel 24, and the upstream and downstream motor supports 23u, 23d are injection molded as two separate parts. In some embodiments, the air guide 20 is molded integrally with the upstream motor support 23u (FIGS. 3b and 4b). In other embodiments, the air guide 20 is molded integrally with the barrel 24 (FIGS. 3c and 4c). An advantage of a two-piece design is that it may reduce the cost of manufacturing the fan assembly.

In FIGS. 3a, 3b, and 3c, the entire barrel 24 is molded integrally with the downstream motor support 23d. This molding strategy is desirable when, as shown in FIG. 3a, the radial dimension rᵤ of the inner surface of the barrel 24 at the upstream end of the barrel 24 is larger than the radial dimension r_{d} of the inner surface of the barrel 24 at the downstream end. It allows the upstream fan blade tips 146u to conform to the barrel inlet portion 241, since the barrel 24 is fastened to the ring structure 29u after the upstream fan 10u is installed. This would not be possible if a significant portion of the barrel inlet portion 241 were molded integrally with the ring structure 29u.

In order to mold the upstream motor support 23u without complex tooling, the trailing edge 264 of the upstream vanes 26u can be formed only at radii smaller than the minimum radial dimension of the inner surface of any barrel portion molded with the ring structure 29u. Molding the entire barrel 24 integrally with the downstream motor support 23d allows the upstream vane trailing edges 264 to be formed along the entire length of the vanes 26u. This allows the vanes 26u to be terminated at a distance from the upstream fan blade tips 146u and reduces the noise generated as the upstream fan blades 14u move through the wakes of the upstream vanes 26u.

The assembly process is as follows. The upstream motor 30u is fastened to the upstream motor mount 28u, and the upstream fan 10u is mounted on the upstream motor 30u. Similarly, the downstream motor 30d is fastened to the downstream motor mount 28d, and the downstream fan 10d is mounted on the downstream motor 30d. The dynamic balance of these fan subassemblies can be checked and corrected. When both fans 10u, 10d are mounted, and any balancing operations completed, the plastic piece comprising the upstream motor support 23u is fastened to the plastic piece comprising the downstream motor support 23d to form the complete fan assembly 2.

The efficient and quiet performance of the free-tipped upstream fan 10u depends on maintaining a small tip gap between the blade tip 146u and the barrel 24. Maintaining the tip gap uniformly around the circumference requires the correct relative positioning of the plastic parts. FIG. 4a is a detailed view of the resulting structure when the three separately molded parts shown in FIG. 3a are joined, showing features that accurately locate the barrel 24 with respect to the ring structure 29u. The upstream end 247 of the barrel inlet portion 241 overlies a portion of the outer surface of the ring structure 29u. A circumferentially-extending ridge 293 protrudes outward from the ring structure outer surface. The ridge 293 is received by a circumferentially-extending groove 248 provided in the inner surface of the barrel inlet portion 241. The cooperative engagement between the ridge 293 and the groove 248 guarantees an accurate mating of the barrel 24 with the ring structure 29u. The barrel 24 and the ring structure 29u can he attached by a circumferential array of fasteners (not shown) at meridional location “b”.

Because the weight of the fan assembly 2 may be supported by the air guide 20, features are provided to assure the robust attachment of the ring structure 29u to the air guide. An upstream end 291 of the ring structure 29u overlies an outer surface of the air guide 20. The upstream end 291 is outwardly offset relative to the downstream end 292, whereby the mid portion of the ring structure 29u is provided with an inner shoulder 294 that abuts the end face of the downstream end 202 of the air guide 20. This serves to locate the fan assembly, and allows the air guide to hear the weight of the fan assembly. The fan assembly 2 can be fastened to the air guide 20 by an array of fasteners (not shown) at meridional location “a”.

FIGS. 4b and 4c are detailed views of the joining of two separately molded parts, as shown in FIGS. 3b and 3c, respectively. Once again, features are provided which guarantee the correct alignment of the barrel 24 and the upstream motor support 23u. The two parts can he attached by a circumferential array of fasteners (not shown) at the meridional location “b”.

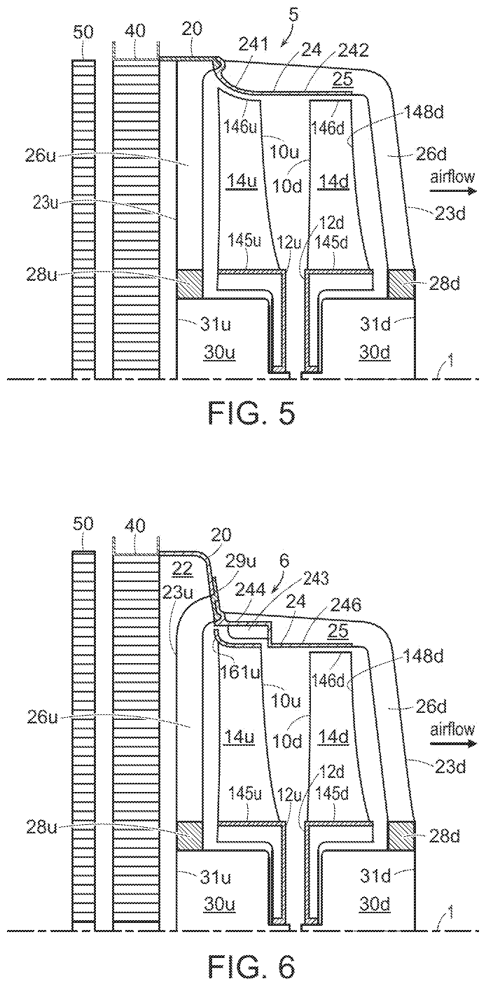

In order to minimize air flow non-uniformity through the heat exchanger, it is desirable for the barrel inlet portion to have almost the same transverse dimension as the smallest dimension of the heat exchanger, which in modern automotive vehicles is often the vertical dimension. FIG. 5 shows an embodiment where the fan assembly 5 is sized in this way. In this embodiment, the air guide 20 and the upstream motor support 23u are molded as a single piece, and in the regions where the barrel inlet portion 241 approaches the axially-extending side wall of the air guide 20, the upstream motor support 23u is connected directly to the side wall.

FIG. 6 shows another embodiment of the fan assembly. In the fan assembly 6 illustrated in FIG. 6, the upstream fan 10u is a banded fan, where the blade tips 146u are connected by a rotating band 16u. The band features a. lip 161u at the leading edge. In addition, the barrel 24 includes a barrel upstream portion 244 and a barrel downstream portion 246, and the inner surface of barrel upstream portion 244 has a larger radial dimension than does the inner surface of barrel downstream portion 246. The barrel upstream portion 244 includes recirculation-control vanes 243, which are described in U.S. Pat. No. 5,489,186. The contents of U.S. Pat. No. 5,489,186 are incorporated by reference herein. The recirculation-control vanes 243 protrude radially inward from the inner surface of the barrel upstream portion 244, and condition the flow that recirculates between the band 16u and the barrel upstream portion 244. The recirculation-control vanes 243 have been shown to increase fan efficiency and reduce fan nurse As in embodiments which include a free-tipped upstream fan, the entire barrel 24 is molded integrally with the downstream motor support 23d. This allows the band 16u and the barrel 24 to feature the recirculation-control features shown without molding and assembling an additional part. As in embodiments which include a free-tipped upstream fan, the barrel 24 is fastened to the ring structure 29u after the upstream fan 10u is installed.

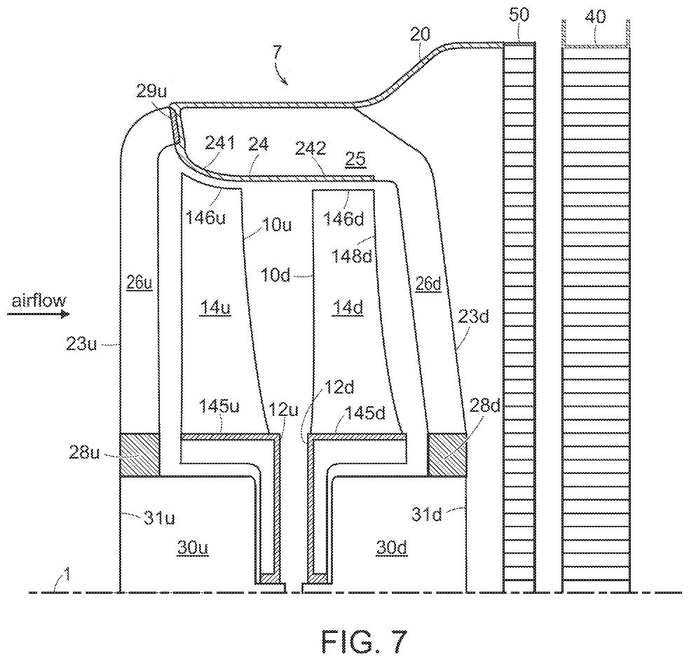

FIG. 7 shows another embodiment of the fan assembly. In the fan assembly 7 illustrated in FIG. 7, the counter-rotating fan assembly 7 is positioned upstream of the radiator 40 and the condenser 50, and pushes air through those heat exchangers. In this embodiment, the air guide 20 is molded integrally with the barrel 24. In other embodiments featuring such a pusher arrangement, the air guide 20 may be molded integrally with the upstream motor support 23u, or may be molded as a separate part.

The placement of motor supports 23u, 23d as described here lends itself to the provision of a finger guard without increasing the number of molded parts. In the case of a puller arrangement, as shown in FIGS. 1a-c, 5, and 6, this finger guard can be molded integrally with the downstream motor support 23d. In the pusher arrangement shown in FIG. 7, it can be molded integrally with the upstream motor support 23u.

Although the heat exchangers shown in the figures are identified as a radiator 40 and a condenser 50, in other embodiments the counter-rotating fan assembly may move air through. various other heat exchangers. In a vehicle powered by an internal combustion engine, these heat exchangers may include charge-air coolers and oil coolers. In an electric vehicle, they may include evaporators and additional radiators.

Although the sectional views shown in the figures show both upstream motor support vanes 26u and downstream motor support vanes 26d, in some embodiments these may be located at different azimuthal positions. In some embodiments there may be a different number of upstream vanes 26u and downstream vanes 26d. However, in embodiments featuring external ribs at the location of the downstream vanes 26d, maximum stiffness is provided when the number and azimuthal locations of upstream and downstream vanes is identical.

Fan assemblies having properties according to one or more aspects of the present application can feature forward-skewed, back-skewed, radial, or mixed-skew fans. Similarly, fan assemblies according to one or more aspects of the present application can feature fans having any number of blades and any distribution of blade angle, camber, chord, or rake.

Selective illustrative embodiments of the fan assembly are described above in some detail. It should be understood that only structures considered necessary for clarifying the fan assembly have been described herein. Other conventional structures, and those of ancillary and auxiliary components of the fan assembly, are assumed to be known and understood by those skilled in the art. Moreover, while a working example of the fan assembly has been described above, the fan assembly is not limited to the working example described above, but various design alterations may be carried out without departing from the fan assembly as set forth in the claims.

We claim:

1. A counter-rotating fan assembly, comprising:
an upstream fan;
a downstream fan that rotates in a direction opposite to a rotational direction of the upstream fan, the upstream fan and the downstream fan rotating about a substantially common rotation axis;
an upstream motor that drives the upstream fan;
an upstream motor support that supports the upstream motor;
a downstream motor that drives the downstream fan;
a downstream motor support that supports the downstream motor; and
a barrel that surrounds at least a portion of the upstream fan and a portion of the downstream fan,
characterized in that,
the upstream motor support is located upstream of the upstream, fan, and
the downstream motor support is located downstream of the downstream fan.

7. The fan assembly of claim 1, where
at least one of the upstream motor support and the downstream rotor support comprise plurality of vanes,
each vane has a cross section that includes a chord line that extends between a leading edge of the vane and a trailing edge of the vane, a chord length that corresponds to the length of the chord line, and a maximum thickness,
the chord length is greater than the maximum thickness, and
the chord line is oriented approximately parallel to the rotation axis.

3. The fan assembly of claim 2, where the chord length is between 4 and 15 times the maximum thickness.

4. The fan assembly of claim 2, where the leading edge is rounded.

5. The fan assembly of claim 2, where the thickness at the trailing edge is less than the maximum thickness.

6. The fan assembly of claim 1, Where
the upstream motor support comprises a plurality of vanes, and
the upstream motor support is plastic, and is molded integrally with a ring structure that connects the outer extremities of the vanes.

7. The fan assembly of claim 1, comprising an air guide configured to guide between a heat exchanger and the fan assembly.

8. The fan assembly of claim 7, wherein the air guide, the barrel, the upstream motor support and the downstream motor support are injection molded of one or more plastic materials.

9. The fan assembly of claim 8, where the upstream motor support is integrally formed with the air guide.

10. The fan assembly of claim 8, where the barrel is integrally formed with the air guide.

11. The fan assembly of claim 8, where the downstream motor support is integrally formed with a portion of the barrel which surrounds at least a portion of the downstream fan and at least a portion of the upstream fan.

12. The fan assembly of claim 11, where a radial dimension of an inner surface of an upstream end of the barrel portion is greater than a radial dimension of an inner surface of a downstream end of the barrel portion.

13. The fan assembly of claim 1, where the fan assembly is configured to be attached to a separate air guide, and the separate air guide is configured to guide air between a heat exchanger and the fan assembly.

14. The fan assembly of claim 1, where the barrel, the upstream motor support and the downstream motor support am in molded of one or more plastic materials.

15. The fan assembly of claim 14, where the downstream motor support is integrally formed with a portion of the barrel which surrounds at least a portion of the downstream fan and at least a portion of the upstream fan.

16. The fan assembly of claim 15, where a radial dimension of an inner surface of an upstream end of the barrel portion is greater than a radial dimension of an inner surface of a downstream end of the barrel portion.

17. The fan assembly of claim 1, where the upstream fan, and the downstream fan are each a free-tipped fan.

18. The fan assembly of claim 1, where at least one of the upstream in and the downstream fan is a banded fan.

19. A method of manufacturing a counter-rotating fan assembly, the fan assembly comprising:
an upstream fan;
a downstream fan that rotates in a direction opposite to a rotational direction of the upstream fan, the upstream fan and the downstream fan rotating about a substantially common rotation axis;
an upstream motor that drives the upstream fan;
an upstream motor support that supports the upstream motor;
a downstream motor that drives the downstream fan;
a downstream motor support that supports the downstream motor; and
a barrel that surrounds at least a portion of the upstream fan and a portion of the downstream fan,
characterized in that,
the upstream motor support is located upstream of the upstream fan, and the downstream motor support is located downstream of the downstream fan,
the method comprising:
assembling a first subassembly that comprises the upstream fan, the upstream motor, and the upstream motor support;
assembling a second subassembly that comprises the downstream fan, the downstream motor, and the downstream motor support; and
assembling the first subassembly with the second subassembly to provide a third subassembly.
